(19) United States
(12) Patent Application Publication
(10) Pub. No.: US 2023/0243416 A1
(43) Pub. Date: Aug. 3, 2023

(54) PLANETARY GEAR MECHANISM WITH FREE-WHEEL MECHANISM

(71) Applicant: NACHI-FUJIKOSHI CORP., Tokyo (JP)

(72) Inventors: Gaku KOSAKI, Toyama (JP); Takaya YOKOTA, Toyama (JP)

(73) Assignee: NACHI-FUJIKOSHI CORP., Tokyo (JP)

(21) Appl. No.: 18/103,682

(22) Filed: Jan. 31, 2023

(30) Foreign Application Priority Data
Feb. 1, 2022 (JP) 2022-014148

(51) Int. Cl. F15B 15/02; F15B 15/20; F16H 57/08; F16H 57/00

(52) U.S. Cl. CPC F15B 15/02; F15B 15/20; F16H 57/0025; F16H 57/082; F15B 2215/30; F16H 2001/324

(57) ABSTRACT

Object: To provide a planetary gear mechanism with a free-wheel mechanism that can prevent seizing of a thrust plate and can increase the degree of freedom in setting of a gear ratio. Means to Solve the Problem: A planetary gear mechanism 100 is a planetary gear mechanism with a free-wheel mechanism for reducing the output of a hydraulic motor 104 and transmitting the reduced output. The planetary gear mechanism 100 includes: a housing 108 configured to be decelerated and rotated; a cover 128 that seals an end surface 126 of the housing; a sun shaft 132 configured to be splined to a motor shaft 106 of the hydraulic motor; a first sun gear 142 formed in one piece with the sun shaft; a first planetary gear 144 meshed with the first sun gear; a carrier 146 that supports a shaft 148 of the first planetary gear; a thrust plate 160 that is disposed toward the cover relative to the first planetary gear, and is configured to restrict a movement of the carrier; a hole 164 that is formed in the thrust plate and through which the first sun gear can be passed; a maintenance hole 166 that is formed in the cover and through which the first sun gear can be passed; and a plug 162 configured to close the maintenance hole.

### FIELD OF THE INVENTION

The present invention relates to a planetary gear mechanism with a free-wheel mechanism that reduces the output of a hydraulic motor and transmits the reduced output.

### BACKGROUND OF THE INVENTION

For example, construction vehicles are constituted by a prime mover such as an engine, a hydraulic pump coupled to the prime mover, a cylinder piped via a hose from the hydraulic pump, and an actuator such as a hydraulic motor. A travel motor in which a hydraulic motor is coupled to a reducer is used as an apparatus for driving crawler belts of a construction vehicle. This travel motor uses the hydraulic motor and the like as a driving source to rotate a rotary drum (housing of the reducer) and transmit a driving force. As the reducer, a planetary gear mechanism having a large reduction ratio is used. Examples of such a travel motor include one having a free-wheel mechanism configured to interrupt a system for transmitting a driving force in the event of, e.g., malfunction of a prime mover such as an engine (for example, Patent Document 1).

Patent Document 1 discloses a travel motor with a free-wheel mechanism. This travel motor includes a hydraulic motor, and a planetary gear reducer coupled to the hydraulic motor. The planetary gear reducer has a coupling joint (sun shaft).

The coupling joint is splined to an output shaft (motor shaft) of the hydraulic motor, and is also splined to an input gear (sun gear) of the planetary gear reducer. Also, a lubricant inspection plug is provided on a back cover of the planetary gear reducer. By removing the lubricant inspection plug, the coupling joint can be externally detached.

According to Patent Document 1, it is possible to interrupt the system for transmitting a driving force by removing, from the outside, the coupling joint that couples and drives the motor shaft of the hydraulic motor and the sun gear of the planetary gear reducer, and it is possible to couple the system for transmitting a driving force by inserting and assembling the coupling joint.

### PRIOR ART DOCUMENT

### Patent Document

Patent Document 1: Japanese Patent Laid-open Publication No. 2003-240066

### SUMMARY OF THE INVENTION

### Problems to Be Solved by the Invention

The travel motor of Patent Document 1 includes a carrier that supports the shaft of the planetary gear of the planetary gear reducer, and a pair of thrust plates for restricting movement of the carrier. One of the pair of thrust plates that is disposed on the back cover side relative to the planetary gear has a hole that is for removing the coupling joint (sun shaft) from the outside.

When the coupling joint is removed from the outside, the splined coupling of the coupling joint and the sun gear is released. Therefore, the hole in the thrust plate is small so that only the coupling joint can pass therethrough. When the hole in the thrust plate is small, the radii of contact surfaces of the thrust plate and the lubricant inspection plug are small, and the area of the contact surfaces is small. Accordingly, friction will increase when torque is applied thereto, and seizing will occur.

Also, in the travel motor of Patent Document 1, the sun gear of the planetary gear reducer has a spline structure, and thus it is difficult to downsize the sun gear and reduce the number of teeth of the sun gear, thus restricting settings of a gear ratio.

The present invention was achieved in light of such problems, and an object of the present invention is to provide a planetary gear mechanism with a free-wheel mechanism that can prevent seizing of a thrust plate and can increase the degree of freedom in setting of a gear ratio.

### Means to Solve the Problem

In order to solve the above-described problems, a representative configuration of a planetary gear mechanism with a free-wheel mechanism according to the present invention relates to a planetary gear mechanism for reducing an output of a hydraulic motor and transmitting the reduced output, including: a housing configured to be decelerated and rotated; a cover that seals an end surface of the housing; a sun shaft configured to be splined to a motor shaft of the hydraulic motor; a sun gear formed in one piece with the sun shaft; a planetary gear meshed with the sun gear; a carrier that supports a shaft of the planetary gear; a thrust plate that is disposed toward the cover relative to the planetary gear, and is configured to restrict movement of the carrier; a hole that is formed in the thrust plate and through which the sun gear can be passed; a maintenance hole that is formed in the cover and through which the sun gear can be passed; and a plug configured to close the maintenance hole.

In the above-described configuration, when the sun shaft formed in one piece with the sun gear is to be removed from the outside, the plug that closes the maintenance hole in the cover is first unscrewed and the sun shaft is pulled out in an axial direction. In response thereto, the splined coupling between the sun shaft and the motor shaft of the hydraulic motor is released. Also, the maintenance hole and the hole formed in the thrust plate are of a size such that the sun gear can be passed therethrough. Therefore, the sun shaft and the sun gear formed in one piece are passed through the hole in the thrust plate and the maintenance hole, and are removed to the outside. In this manner, the above-described configuration can realize a so-called free-wheel mechanism that enables the housing to freely rotate, by releasing the driving coupling between the motor shaft of the hydraulic motor and the sun gear to interrupt a system for transmitting a driving force, in the event of malfunction of a prime mover such as an engine or for inspection thereof.

Also, the thrust plate has a large hole through which the sun gear can be passed. Accordingly, compared to a case where the thrust plate has a small hole through which only the sun shaft can be passed, the radii of contact surfaces of the thrust plate and the plug are larger and the area of the contact surfaces is larger. Thus, friction that occurs when torque is applied thereto is reduced, and seizing of the thrust plate can be suppressed.

Furthermore, in the above-described configuration, the sun gear and the sun shaft are formed in one piece, instead of being splined to each other, and thus the sun gear does not need to have a spline structure. Therefore, it is possible to downsize the sun gear, and reduce the number of teeth of the sun gear, thus increasing the degree of freedom in setting of the gear ratio.

Preferably, the above-described plug is screwed into the maintenance hole, and further includes an O-ring for sealing.

Since the plug includes the O-ring for sealing as described above, it is possible to seal reducer oil and prevent leakage of the reducer oil. Also, the plug is not a special exclusive part but has a common structure with which it is screwed into the maintenance hole, and thus is readily available. Furthermore, since the plug is screwed into the maintenance hole, the torque for fastening the plug is larger than the torque generated by the sun gear. Accordingly, the above-described configuration can prevent the plug from becoming loose.

### Effects of the Invention

According to the present invention, it is possible to provide a planetary gear mechanism with a free-wheel mechanism that can prevent seizing of a thrust plate and increase the degree of freedom in setting of a gear ratio.

### BRIEF EXPLANATION OF THE DRAWINGS

FIG. 1 is a schematic longitudinal cross-sectional view illustrating a travel motor to which a planetary gear mechanism with a free-wheel mechanism according to an embodiment of the present invention is applied. FIG. 2 is an enlarged view of the main portion of the planetary gear mechanism of FIG. 1.

### EMBODIMENTS OF THE INVENTION

Referring to the accompanying drawings, the following is a detailed explanation of preferred embodiments of the present invention. All dimensions, materials, and other specific numbers shown in the embodiment are merely given as examples in order to aid the understanding of the invention, and are not meant to limit the present invention, unless otherwise explicitly stated. It should be further noted that throughout this specification and in the drawings, elements that have substantially the same functionality and/or structure are denoted with the same reference numerals and are not described redundantly. Furthermore, elements that are not directly related to the present invention may not necessarily be shown in the figures.

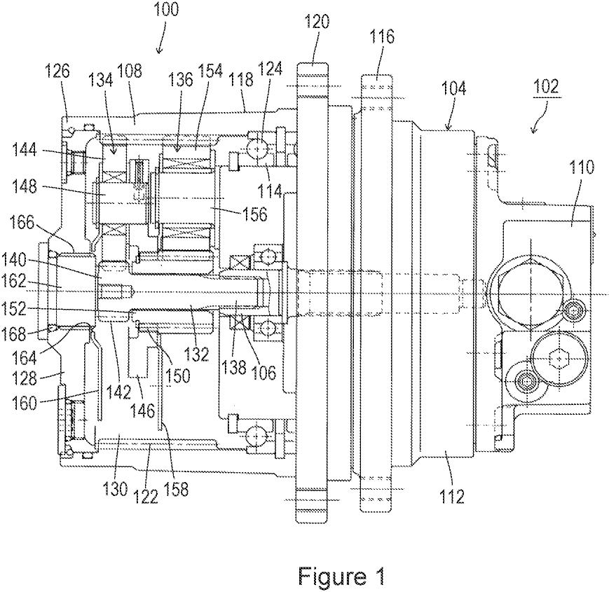

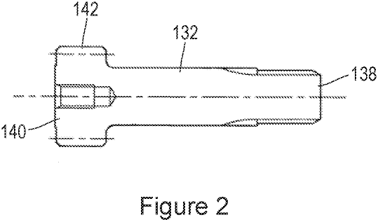

FIG. 1 is a schematic longitudinal cross-sectional view illustrating a travel motor 102 to which a planetary gear mechanism 100 with a free-wheel mechanism according to an embodiment of the present invention is applied. FIG. 2 is an enlarged view of the main portion of the planetary gear mechanism 100 of FIG. 1.

As shown in FIG. 1, the travel motor 102 includes the planetary gear mechanism 100, and a hydraulic motor 104 serving as a driving source. The planetary gear mechanism 100 reduces rotation (output) from a motor shaft 106 of the hydraulic motor 104, and transmits a large rotative force (torque) to a tubular housing 108, which is the exterior of the planetary gear mechanism 100 and serves as a rotary drum. That is, in the travel motor 102, the housing 108 of the planetary gear mechanism 100 decelerates and rotates in response to rotation of the motor shaft 106 of the hydraulic motor 104,

The hydraulic motor 104 is constituted by a piping port 110, a motor casing 112, the above-described motor shaft 106, an unshown cylinder block, a piston, a variable capacity mechanism, and the like. The hydraulic motor 104 uses compressed oil supplied or discharged from an unshown hydraulic pump via the piping part 110 to rotate the motor shaft 106, and changes the number of rotations of the motor shaft 106 using the variable capacity mechanism.

The motor casing 112 functions as the outer shell of the hydraulic motor 104, and an outer circumferential surface 114 thereof is provided with a fixed flange 116. The fixed flange 116 is fixed to the frame of an unshown construction vehicle (such as a crawler-type hydraulic shovel) or the like using bolts or the like.

An outer circumferential surface 118 of the housing 108 of the planetary gear mechanism 100 is provided with a driving flange 120. The driving flange 120 is fixed to a sprocket that drives crawler belts of the construction vehicle or the like using bolts or the like, and causes the construction vehicle such as a hydraulic shovel to travel. Also, inside the housing 108, a reducer internal gear 122 is formed over the entire circumference of the housing 108.

Furthermore, the housing 108 of the planetary gear mechanism 100 is rotatably supported on the motor casing 112 of the hydraulic motor 104 by a bearing 124. The bearing 124 is fitted to the outer circumferential surface 114 of the motor casing 112. Also, an end surface 126 of the housing 108 is sealed by a cover 128.

The planetary gear mechanism 100 includes a reducer chamber 130. The reducer chamber 130 is a region surrounded by the housing 108, the cover 128, and the motor casing 112 of the hydraulic motor 104. The planetary gear mechanism 100 further includes a sun shaft 132, and two-stage planetary gear reducing mechanisms 134 and 136. The sun shaft 132 and the two-stage planetary gear reducing mechanisms 134 and 136 are housed in the reducer chamber 130.

The sun shaft 132 includes one end portion 138 (see FIG. 2) splined to the motor shaft 106 of the hydraulic motor 104, and the other end portion 140 formed in one piece with a sun gear (first sun gear 142). Therefore, the first sun gear 142 rotates together with the sun shaft 132 splined to the motor shaft 106.

The planetary gear reducing mechanism 134 is disposed in the reducer chamber 130 on the cover 128 side, and includes the first sun gear 142, a plurality of (e.g., three) first planetary gears 144, and a carrier 146. The first sun gear 142 is coupled to the motor shaft 106 of the hydraulic motor 104, and rotates together therewith. The first planetary gears 144 rotate and orbit by meshing with the first sun gear 142 and the reducer internal gear 122 of the housing 108. The carrier 146 supports shafts 148 of the first planetary gears 144. Also, the carrier 146 has a carrier internal gear 150.

The planetary gear reducing mechanism 136 is arranged on the side closer to the hydraulic motor 104 than the planetary gear reducing mechanism 134 is, and includes a second sun gear 152 and a plurality of (e.g., three) second planetary gears 154. The second sun gear 152 meshes with the carrier internal gear 150 of the carrier 146.

The second planetary gears 154 mesh with the second sun gear 152 and the reducer internal gear 122 of the housing 108. Also, each shaft 156 of the second planetary gears 154 is a fixed shaft that is coupled to the motor casing 112. Therefore, the second planetary gears 154 rotate but do not orbit.

In the planetary gear mechanism 100, since the second planetary gears 154 mesh with the reducer internal gear 122, rotation of the second planetary gears 154 rotates the housing 108 formed in one piece with the reducer internal gear 122. With this configuration, in the planetary gear mechanism 100, the housing 108 can rotate with a large reduction ratio as the motor shaft 106 of the hydraulic motor 104 rotates.

The planetary gear mechanism 100 further includes a pair of thrust plates 158 and 160, and a plug 162. The thrust plate 158 is fitted to the shafts 156 of the second planetary gears 154, and restricts movement of the carrier 146 so that the carrier 146 does not move toward the hydraulic motor 104.

The thrust plate 160 is disposed on the cover 128 side relative to the first planetary gears 144, is coupled to the shafts 148 of the first planetary gears 144, and restricts movement of the carrier 146 so that the carrier 146 does not move toward the cover 128. That is, restricting movement of the carrier 146 has the aim of restricting misalignment between tooth faces of the first planetary gears 144 and the first sun gear 142.

Also, the thrust plate 160 has a hole 164 through which the first sun gear 142 can be passed. The cover 128 has a maintenance hole 166 through which the first sun gear 142 can be passed. The plug 162 is screwed into the maintenance hole 166 in the cover 128 and closes the maintenance hole 166. The plug 162 also includes an O-ring 168 for sealing.

Here, the planetary gear mechanism 100 realizes a so-called free-wheel mechanism that enables the housing 108 to freely rotate, by releasing the driving coupling between the motor shaft 106 of the hydraulic motor 104 and the first sun gear 142 to interrupt a system for transmitting a driving force, in the event of malfunction of a prime mover such as an engine or for inspection thereof.

That is, in the planetary gear mechanism 100, when the sun shaft 132 formed in one piece with the first sun gear 142 is to be removed from the outside, the plug 162 that closes the maintenance hole 166 in the cover 128 is first unscrewed and the sun shaft 132 is pulled out in the axial direction. In response thereto, the splined coupling between one end portion 138 (see FIG. 2) of the sun shaft 132 and the motor shaft 106 of the hydraulic motor 104 is released.

The hole 164 in the thrust plate 160 and the maintenance hole 166 in the cover 128 are of a size such that the first sun gear 142 can be passed therethrough, as described above. Therefore, when the splined coupling between the sun shaft 132 and the motor shaft 106 is released, the sun shaft 132 and the first sun gear 142 formed in one piece are passed through the hole 164 in the thrust plate 160 and the maintenance hole 166 in the cover 128 and are removed to the outside. In this way, in the planetary gear mechanism 100, the free-wheel mechanism can be realized.

Also, the hole 164 in the thrust plate 160 is a large hole through which the first sun gear 142 can be passed. Accordingly, compared to a case where the thrust plate 160 has a small hole through which only the sun shaft 132 can be passed, the radii of contact surfaces of the thrust plate 160 and the plug 162 of the planetary gear mechanism 100 are larger and the area of the contact surfaces is larger. Thus, according to the planetary gear mechanism 100, friction that occurs when torque is applied thereto is thus reduced, and seizing of the thrust plate 160 can be suppressed.

Also, in the planetary gear mechanism 100, the first sun gear 142 and the sun shaft 132 are formed in one piece, instead of being splined to each other, and thus the first sun gear 142 does not need to have a spline structure. Accordingly, in the planetary gear mechanism 100, it is possible to downsize the first sun gear 142, and reduce the number of teeth of the first sun gear 142, thus increasing the degree of freedom in setting of the gear ratio.

Also, in the planetary gear mechanism 100, since the plug 162 includes the O-ring 168 for sealing, it is possible to seal reducer oil and prevent leakage of the reducer oil. Furthermore, in the planetary gear mechanism 100, since the plug 162 is screwed into the maintenance hole 166, the torque for fastening the plug 162 is larger than the torque generated by the first sun gear 142, thus making it possible to prevent the plug 162 from becoming loose. Furthermore, the plug 162 is not a special exclusive part but has a common structure with which it is screwed into the maintenance hole 166, and is thus readily available.

Although preferred embodiments of the present invention have been described above with reference to the accompanying drawings, the present invention is needless to say not limited to these examples. A person skilled in the art will appreciate that various modifications and alterations can be made within the scope of the claims, and that all such modifications and alterations are also naturally encompassed in the technical scope of the present invention.

### INDUSTRIAL APPLICABILITY

The present invention is applicable as a planetary gear mechanism with a free-wheel mechanism that reduces the output of a hydraulic motor and transmits the reduced output.

### INDEX TO THE REFERENCE NUMERALS

100 ... Planetary gear mechanism, 102 ... Travel motor, 104 ... Hydraulic motor, 106 ... Motor shaft, 108 ... Housing, 110 ... Piping port, 112 ... Motor casing, 114 ... Outer circumferential surface of motor casing, 116 ... Fixed flange, 118 ... Outer circumferential surface of housing, 120 ... Driving flange, 122 ... Reducer internal gear, 124 ... Bearing, 126 ... End surface of housing, 128 ... Cover, 130 ... Reducer chamber, 132 ... Sun shaft, 134, 136 ... Planetary gear reducing mechanism, 138... One end portion of sun shaft, 140 ... The other end portion of sun shaft, 142 ... First sun gear, 144 ... First planetary gear, 146 ... Carrier, 148 ... Shaft of first planetary gear, 150 ... Carrier internal gear, 152 ... Second sun gear, 154 ... Second planetary gear, 156 ... Shaft of second planetary gear, 158, 160 ... Thrust plate, 162 ... Plug, 164 ... Hole in thrust plate, 166 ... Maintenance hole, 168 ... O-ring

1. A planetary gear mechanism with a free-wheel mechanism for reducing an output of a hydraulic motor and transmitting the reduced output, comprising:
a housing configured to be decelerated and rotated;
a cover that seals an end surface of the housing;
a sun shaft configured to be splined to a motor shaft of the hydraulic motor;
a sun gear formed in one piece with the sun shaft;
a planetary gear meshed with the sun gear;
a carrier that supports a shaft of the planetary gear;
a thrust plate that is disposed toward the cover relative to the planetary gear, and is configured to restrict movement of the carrier;
a hole that is formed in the thrust plate and through which the sun gear can be passed;
a maintenance hole that is formed in the cover and through which the sun gear can be passed; and
a plug configured to close the maintenance hole.

2. The planetary gear mechanism with a free-wheel mechanism according to claim 1,
wherein the plug is screwed into the maintenance hole, and further includes an O-ring for sealing.
